(19) United States
(12) Patent Application Publication
(10) Pub. No.: US 2025/0137656 A1
(43) Pub. Date: May 1, 2025

(54) HEATING COOKER

(71) Applicant: SHARP KABUSHIKI KAISHA, Sakai City (JP)

(72) Inventor: SHINJI ASAMI, Sakai City (JP)

(21) Appl. No.: 18/928,436

(22) Filed: Oct. 28, 2024

(30) Foreign Application Priority Data
Oct. 31, 2023 (JP) 2023-186346

(51) Int. Cl. F24C 15/00; F24C 7/08

(52) U.S. Cl. CPC F24C 15/006; F24C 7/085

(57) ABSTRACT

A heating cooker includes a heating cooking compartment, a housing, a circuit board, an air blower, and a division partition. The division partition includes a board case configured to accommodate the circuit board. The board case includes a bottom wall portion functioning as a partition between the heating cooking compartment and the circuit board. The circuit board is disposed apart from the bottom wall portion. A first blow-out port is disposed at a position spanning between a surface on one side and a surface on another side of the circuit board. The board case includes, on the bottom wall portion, a flow restricting portion restricting a flow quantity of air flowing in the board case.

### BACKGROUND OF THE INVENTION

### 1. Technical Field

The present disclosure relates to a heating cooker. This application claims the benefit of priority to Japanese Patent Application Number 2023-186346 filed on Oct. 31, 2023. The entire contents of the above-identified application are hereby incorporated by reference.

### 2. Description of the Related Art

A heating cooker of JP 2000-346371 A includes an inverter circuit board and a cooling fan. In the heating cooker disclosed in JP 2000-346371 A, either a front or back surface of the inverter circuit board is disposed in an air passage on an upstream side from the cooling fan, and the other surface is disposed in the air passage on a downstream side.

### SUMMARY OF THE INVENTION

The heating cooker disclosed in JP 2000-346371 A uniformly cools both the front and back surfaces of the inverter circuit board, and is not configured to effectively cool a specific portion of the inverter circuit board.

In view of the above problem, an object of the present disclosure is to provide a heating cooker capable of effectively cooling a specific portion of an inverter circuit board.

According to one aspect of the present disclosure, a heating cooker includes a heating cooking compartment, a housing, a circuit board, an air blower, and a division partition. The heating cooking compartment accommodates a heating-target object. The housing accommodates the heating cooking compartment. The circuit board is disposed between the housing and the heating cooking compartment. The air blower has a first blow-out port accommodating a first blast fan and blowing out air toward the circuit board, and the air blower forms a first blast fan air flow with air blown out from the first blow-out port. The division partition divides a flow channel through which the first blast fan air flow flows from the first blow-out port toward the circuit board. The division partition includes a board case configured to accommodate the circuit board. The board case includes a bottom wall portion functioning as a partition between the heating cooking compartment and the circuit board. The circuit board is disposed apart from the bottom wall portion. The first blow-out port is disposed at a position spanning between a surface on one side and a surface on the other side of the circuit board. The board case includes, on the bottom wall portion, a flow restricting portion restricting a flow quantity of air flowing in the board case.

According to the present disclosure, the heating cooker is capable of effectively cooling a specific portion of an inverter circuit board.

### BRIEF DESCRIPTION OF THE DRAWINGS

FIG. 1 is a perspective view illustrating a heating cooker according to an embodiment of the present disclosure;

FIG. 2 is a perspective view illustrating the heating cooker in a state where a housing except for a front wall thereof is removed according to the embodiment;

FIG. 3 is a perspective view illustrating the heating cooker in a state where the housing except for the front wall thereof is removed according to the embodiment;

FIG. 4 is a perspective view illustrating a door according to the embodiment;

FIG. 5 is a view illustrating a schematic cross section of the heating cooker according to the embodiment;

FIG. 6 is a view illustrating a schematic cross section of an air blower according to the embodiment;

FIG. 7 is a perspective view illustrating the heating cooker in a state where the housing except for a front wall thereof is removed according to the embodiment;

FIG. 8 is a plan view illustrating the heating cooker in a state where the housing except for the front wall thereof is removed according to the embodiment;

FIG. 9 is a perspective view illustrating an inverter unit according to the embodiment;

FIG. 10 is a plan view illustrating the inverter unit according to the embodiment;

FIG. 11 is a cross-sectional view along line XI-XI in FIG. 10; and

FIG. 12 is a block diagram illustrating a configuration of the heating cooker according to the embodiment.

### DETAILED DESCRIPTION

Hereinafter, with reference to the drawings, an embodiment of a heating cooker according to the present disclosure will be described. Note that, in the drawings, the same or corresponding portions are denoted by the same reference numerals, and descriptions thereof will not be repeated.

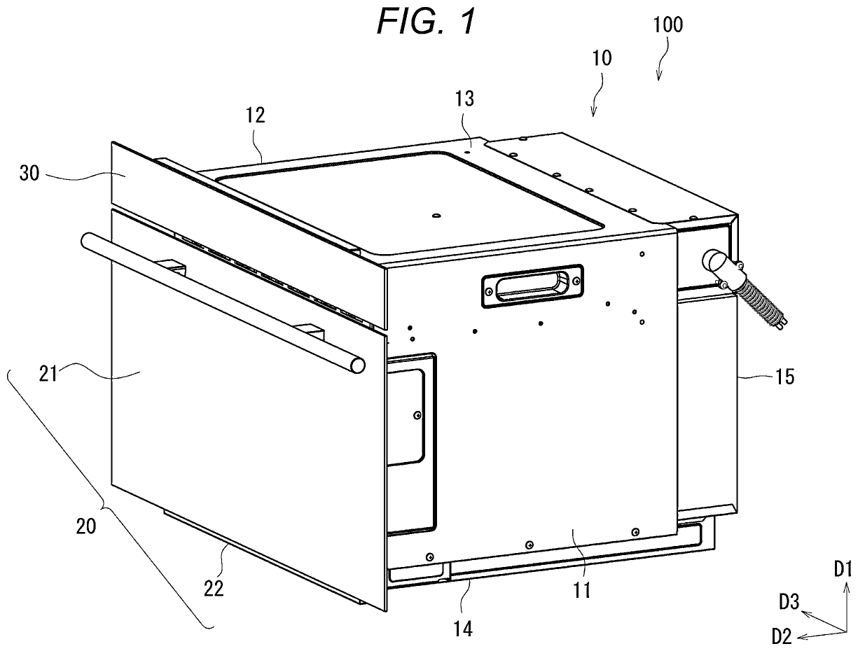

With reference to FIG. 1, a heating cooker 100 according to the embodiment will be described. FIG. 1 is a perspective view illustrating the heating cooker 100. In addition, FIG. 1 illustrates the external appearance of the heating cooker 100 when viewed diagonally from the upper right front. As illustrated in FIG. 1, the heating cooker 100 heats and cooks a heating-target object. The heating-target object is, for example, a food item. The heating cooker 100 includes a housing 10, a door 20, and an operation panel 30.

The operation panel 30 is a substantially rectangular plate-shaped member. The operation panel 30 receives an operation from a user. The operation includes, for example, a cooking method for heating and cooking a heating-target object. Specifically, the operation panel 30 includes a display unit. The display unit displays various items of information. Specifically, the display unit includes a liquid crystal panel.

In the embodiment, a side of the heating cooker 100 on which the operation panel 30 is disposed is defined as a front side of the heating cooker 100, and a side (back surface side) opposite to the front side is defined as a rear side of the heating cooker 100. In addition, when the heating cooker 100 is viewed from the front side, a right side is defined as a right side of the heating cooker 100, and a side opposite to the right side is defined as a left side of the heating cooker 100. In addition, in a direction orthogonal to a front-rear direction and a left-right direction of the heating cooker 100, a side on which the operation panel 30 is disposed is defined as an upper side of the heating cooker 100, and a side (bottom side) opposite to the upper side is defined as a lower side of the heating cooker 100. Note that, these directions and sides are not intended to limit directions and sides when the heating cooker 100 of the present disclosure is used. In the embodiment, a first direction D1 is an upward direction. A second direction D2 is a forward direction. A third direction D3 is a left direction.

The housing 10 is a box-shaped member. Specifically, the housing 10 has a right outer wall 11, a left outer wall 12, an upper outer wall 13, a lower outer wall 14, a rear outer wall 15, and a front wall 60 to be described below. The rear outer wall 15 intersects the second direction D2. The right outer wall 11 and the left outer wall 12 face each other in the third direction D3. The upper outer wall 13 and the lower outer wall 14 face each other in the first direction D1. The housing 10 accommodates the heating cooking compartment 50 to be described below.

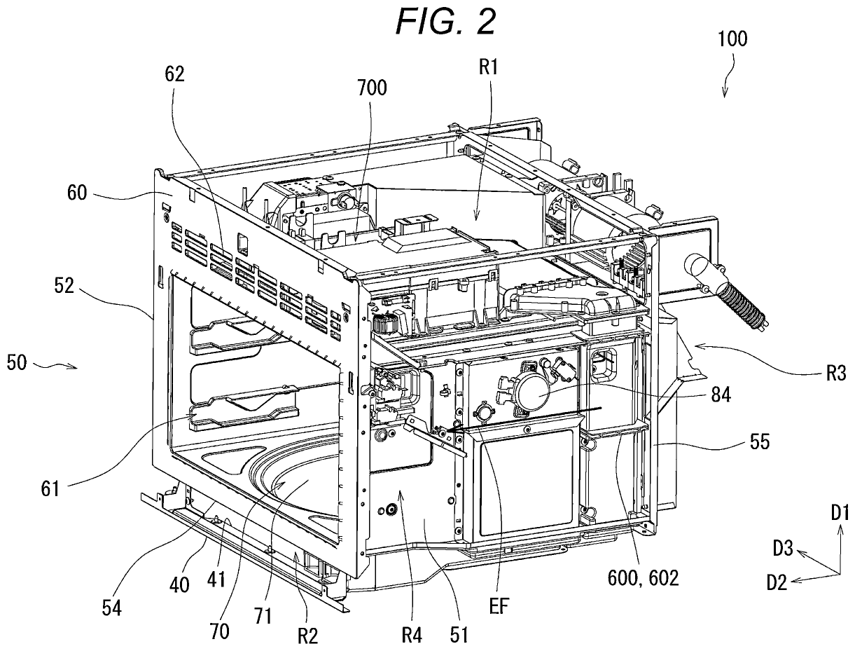

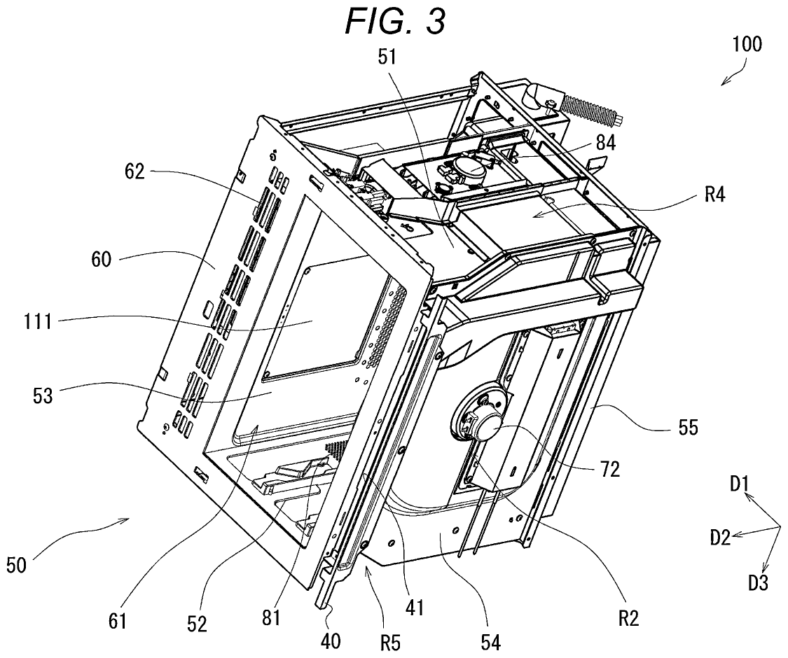

Continuing, a heating cooking compartment 50 will be described with reference to FIGS. 1 to 3. Continuing, FIGS. 2 and 3 are perspective views illustrating the heating cooker 100 in a state where the housing 10 except for the front wall 60 thereof is removed. FIG. 2 illustrates the external appearance of the heating cooker 100 when viewed diagonally from the upper right front. FIG. 3 illustrates the external appearance of the heating cooker 100 when viewed diagonally from the lower right front. As illustrated in FIGS. 2 and 3, the heating cooker 100 further includes the heating cooking compartment 50 and a placement portion 70.

The heating cooking compartment 50 allows a heating-target object to be accommodated therein. The heating cooking compartment 50 is accommodated in the housing 10. The heating cooking compartment 50 has, for example, a substantially rectangular parallelepiped shape. Specifically, the heating cooking compartment 50 has a right wall 51, a left wall 52, an upper wall 53, a lower wall 54, and a rear wall 55. The rear wall 55 intersects the second direction D2. The right wall 51 and the left wall 52 face each other in the third direction D3. The upper wall 53 and the lower wall 54 face each other in the first direction D1.

The placement portion 70 is a dish-shaped member. The placement portion 70 is accommodated in the heating cooking compartment 50. The placement portion 70 is configured to allow the heating-target object to be placed. As illustrated in FIGS. 2 and 3, the placement portion 70 includes a table 71 and a drive motor 72. The placement portion 70 is rotatable about a rotation axis in the first direction D1.

The heating-target object is placed on the table 71. The table 71 is disposed at the center of the lower wall 54.

The drive motor 72 rotates the table 71. To be specific, the drive motor 72 rotates the table 71 about a rotation axis in the first direction D1. The drive motor 72 is disposed below the heating cooking compartment 50.

The heating cooker 100 further includes a first space R1, a second space R2, a third space R3, a fourth space R4, and a fifth space R5. The first space R1 is disposed between the upper outer wall 13 and the upper wall 53. The second space R2 is disposed between the lower outer wall 14 and the lower wall 54. The third space R3 is disposed between the rear outer wall 15 and the rear wall 55. The fourth space R4 is disposed between the right outer wall 11 and the right wall 51. The fifth space R5 is disposed between the left outer wall 12 and the left wall 52.

The front wall 60 is a plate-shaped member having a quadrangular shape. The front wall 60 faces the rear wall 55. In addition, the front wall 60 faces the rear outer wall 15. The front wall 60 has an opening 61 and suction ports 62. The opening 61 allows an inside and an outside of the heating cooking compartment 50 to communicate with each other. The suction ports 62 suction air from the outside of the heating cooker 100. That is, the housing 10 has the suction ports 62 through which air is suctioned from the outside of the heating cooker 100. In other words, the housing 10 has the front wall 60 in which the suction ports 62 are formed.

The right wall 51 and the left wall 52 face each other with the upper wall 53 and the lower wall 54 interposed therebetween. The rear wall 55 faces the opening 61.

A plurality of suction ports 62 are disposed above the opening 61. Each of the plurality of suction ports 62 allows an inside and an outside of the first space R1 to communicate with each other. The plurality of suction ports 62 form eight columns. In each of the eight columns of the suction ports 62, three suction ports 62 are arranged in a column in an up-down direction.

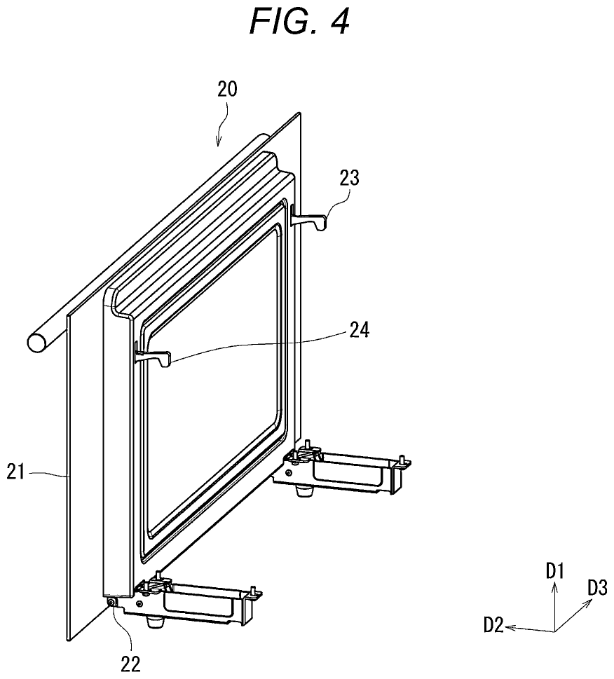

Continuing, the door 20 will be described with reference to FIGS. 1 to 4. FIG. 4 is a perspective view illustrating the door 20. The door 20 opens and closes the opening 61. As illustrated in FIGS. 1 to 4, the door 20 includes a substantially rectangular plate-shaped member 21 and a rotary shaft unit 22.

The rotary shaft unit 22 is positioned below the plate-shaped member 21. The plate-shaped member 21 opens and closes the opening 61. Specifically, the plate-shaped member 21 rotates about a rotation axis in the third direction D3. The plate-shaped member 21 opens the opening 61 in a state of being orthogonal to the first direction D1. On the other hand, the plate-shaped member 21 closes the opening 61 in a state of being orthogonal to the second direction D2.

To be specific, the door 20 includes a first connection member 23 and a second connection member 24. Both the first connection member 23 and the second connection member 24 connect the heating cooking compartment 50 and the door 20 when the door 20 is positioned at a closed position.

The first connection member 23 and the second connection member 24 are attached to the plate-shaped member 21. The first connection member 23 and the second connection member 24 face each other in the left-right direction. The first connection member 23 is attached to a left edge portion of a rear surface of the plate-shaped member 21. The second connection member 24 is attached to a right edge portion of the rear surface of the plate-shaped member 21.

For example, each of the first connection member 23 and the second connection member 24 has a hook member. The hook member is a plate-shaped member having a longitudinal direction thereof in the front-rear direction. The hook member includes a claw portion and a rotation pin portion. The rotation pin portion is positioned at one end portion of the hook member. The rotation pin portion rotates about a rotation axis extending in the third direction D3. On the other hand, the claw portion has a projecting portion projecting downward. The claw portion is positioned at the other end portion of the hook member. As a result, the claw portion is rotatable around the rotation pin portion. The claw portion can engage with a hole formed in the front wall 60.

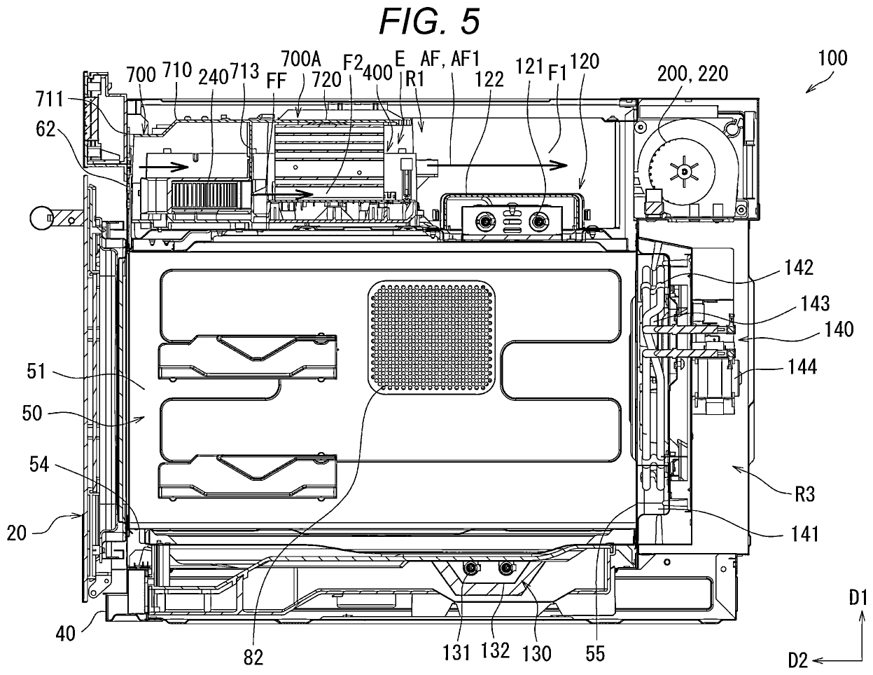

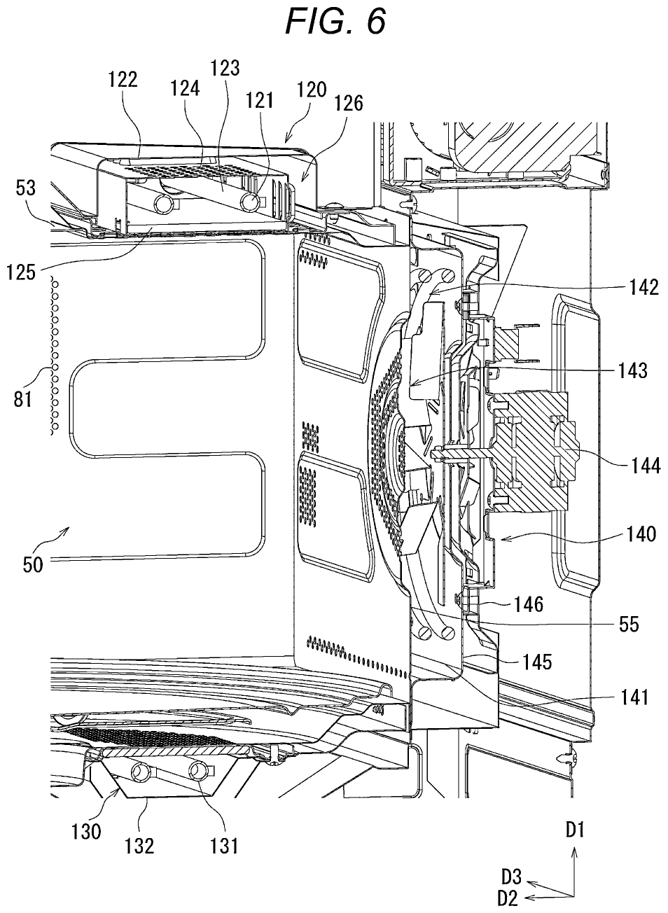

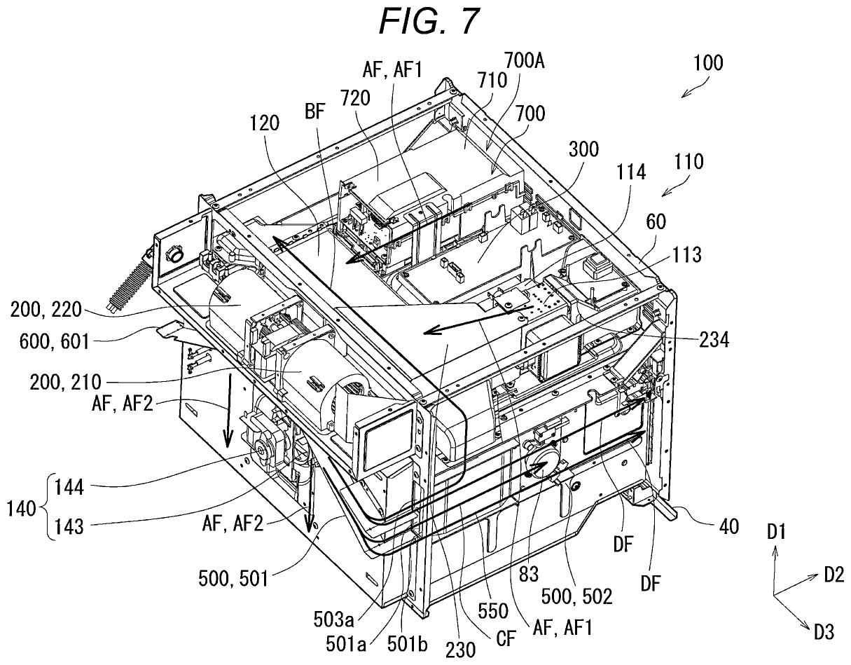

Next, the heating cooker 100 will be further described with reference to FIGS. 5 to 7. FIG. 5 is a view illustrating a schematic cross section of the heating cooker 100. To be specific, FIG. 5 is a cross-sectional view illustrating the heating cooker 100 cut along a plane orthogonal to the third direction D3. In addition, FIG. 6 is a view illustrating a schematic cross section of an air blower 140 according to the embodiment. Further, FIG. 7 is a perspective view illustrating the heating cooker 100 in a state where the housing 10 except for the front wall 60 thereof is removed. To be specific, FIG. 7 illustrates the external appearance of the heating cooker 100 when viewed diagonally from the upper left rear.

The heating cooker 100 further includes a discharge unit 40. As illustrated in FIGS. 2, 3, 5, and 7, the discharge unit 40 partitions between an inside and an outside of the second space R2. The discharge unit 40 is a plate-shaped member having a crank cross sectional shape. A lower portion of the discharge unit 40 is bent toward the front side. A length of the discharge unit 40 in the left-right direction is set to be substantially the same as a length of the lower wall 54 in the left-right direction. A front end of the discharge unit 40 is positioned behind a front end of the door 20.

The discharge unit 40 is disposed below the opening 61. An upper portion of the discharge unit 40 is fixed to a lower surface of the lower wall 54. As illustrated in FIGS. 2 and 3, the discharge unit 40 forms discharge ports 41 in cooperation with the front wall 60.

As illustrated in FIGS. 5 to 7, the heating cooker 100 includes a microwave supply unit 110, a first heater unit 120, a second heater unit 130, and the air blower 140. Each of the microwave supply unit 110, the first heater unit 120, the second heater unit 130, and the air blower 140 heats the heating-target object.

First, the microwave supply unit 110 will be described. The microwave supply unit 110 supplies microwaves into the heating cooking compartment 50.

The microwave supply unit 110 is disposed on the upper wall 53 of the heating cooking compartment 50. Specifically, the microwave supply unit 110 is positioned above the heating cooking compartment 50 with the upper wall 53 interposed therebetween. As illustrated in FIGS. 3 and 7, the microwave supply unit 110 includes a partition member 111, a radiation chamber, a magnetron 113, and a waveguide 114.

The magnetron 113 is disposed closer to the front wall 60 than the first heater unit 120. The magnetron 113 generates microwaves. The waveguide 114 propagates microwaves generated by the magnetron 113 to the radiation chamber.

As illustrated in FIG. 3, the partition member 111 is disposed between the radiation chamber and the upper wall 53 of the heating cooking compartment 50. Examples of a material of the partition member 111 are non-metals, and include a ceramic or mica. As a result, since the material of the partition member 111 includes a ceramic or mica, the partition member 111 transmits microwaves. On the other hand, materials of the radiation chamber and the waveguide 114 (see FIG. 7) include metals.

Next, the first heater unit 120 will be described. As illustrated in FIGS. 5 and 6, the first heater unit 120 is disposed above the heating cooking compartment 50. Specifically, the first heater unit 120 is disposed on the upper wall 53 of the heating cooking compartment 50. The first heater unit 120 includes a first heater 121, a thermal shield plate 122, a first tube 123, a heat reflection plate 124, and a glass plate 125.

The first heater 121 is, for example, a carbon heater. The first heater 121 in the state of power application generates heat. As a result, since the temperature rises quickly, the heating-target object can be cooked in a short time.

The thermal shield plate 122 shields heat. The thermal shield plate 122 covers an upper side, a front side, and a rear side of the first heater 121. The thermal shield plate 122 is made of a material including metal.

The first tube 123 is made of glass. The first tube 123 accommodates the first heater 121. The first tube 123 extends in the third direction D3.

The heat reflection plate 124 covers an upper side, a front side, and a rear side of the first heater 121. The heat reflection plate 124 reflects heat toward the heating cooking compartment 50. An air layer 126 is provided between the heat reflection plate 124 and the thermal shield plate 122.

The glass plate 125 is a substantially rectangular plate-shaped member. The glass plate 125 is disposed between a lower side of the first tube 123 and the heating cooking compartment 50. In other words, the glass plate 125 separates the first tube 123 from the heating cooking compartment 50. As a result, the glass plate 125 transmits heat rays from the first heater 121 to the heating cooking compartment 50. On the other hand, the glass plate 125 prevents moisture and salt from moving from the heating cooking compartment 50 to the first tube 123. Accordingly, a devitrification phenomenon of the first tube 123 can be prevented.

Next, the second heater unit 130 will be described. As illustrated in FIGS. 5 and 6, the second heater unit 130 is disposed on the lower wall 54 of the heating cooking compartment 50. The second heater unit 130 includes a second heater 131 and a second heater case 132. The second heater 131 is, for example, a nichrome wire. The second heater 131 in the state of power application generates heat. An output of the second heater 131 is lower than an output of the first heater 121. The second heater case 132 covers a lower side, a front side, and a rear side of the second heater 131. The second heater case 132 is made of a material including metal. The second heater 131 in the state of power application generates heat.

Next, the air blower 140 will be described. The air blower 140 is configured to supply hot air into the heating cooking compartment 50. The air blower 140 is disposed in the third space R3. Specifically, the air blower 140 is positioned behind the heating cooking compartment 50 with the rear wall 55 interposed therebetween.

As illustrated in FIGS. 5 to 7, the air blower 140 includes an air blowing chamber 141, a third heater 142, a centrifugal fan 143, a drive unit 144, a partition member 145, and a heat shield plate 146. The air blowing chamber 141 is, for example, a box-shaped member made of metal. The centrifugal fan 143 has a plurality of blades.

The third heater 142 and the centrifugal fan 143 are accommodated in the air blowing chamber 141. The third heater 142 heats air inside the air blowing chamber 141 to generate hot air. Specifically, the third heater 142 has an annular shape when viewed from the front side toward the rear side. The third heater 142 is disposed along an outer circumference of the centrifugal fan 143.

As illustrated in FIG. 6, the rear wall 55 has a suction hole portion and a blow-out hole portion. To be specific, the suction hole portion is, for example, a group of a plurality of punched holes. Similarly, the blow-out hole portion is also, for example, a group of a plurality of punched holes. A punched hole has, for example, a circular shape. A diameter of a punched hole of each of the suction hole portion and the blow-out hole portion is, for example, 3 mm or larger and 4 mm or smaller in order to prevent microwaves from leaking from the inside of the heating cooking compartment 50. The diameter is preferably 3.4 mm.

The partition member 145 is, for example, a plate-shaped member made of metal. The partition member 145 has, for example, an oblong shape when viewed from the front side toward the rear side. The partition member 145 is disposed on substantially the entire surface of the rear wall 55. Specifically, the partition member 145 is positioned on the outward side from the rear wall 55.

The heat shield plate 146 is, for example, a plate-shaped member made of metal. The heat shield plate 146 is, for example, a plate-shaped member having a quadrangular shape when viewed from the front side toward the rear side. The heat shield plate 146 is positioned on the outward side from the partition member 145.

The drive unit 144 is positioned an outward side from the air blowing chamber 141. Specifically, the drive unit 144 is positioned on an outward side from the heat shield plate 146, and a shaft portion of the drive unit 144 penetrates the partition member 145 and the heat shield plate 146 and is connected to the centrifugal fan 143. The drive unit 144 drives the centrifugal fan 143. The drive unit 144 includes, for example, a motor. The drive unit 144 is disposed between the housing 10 and the heating cooking compartment 50.

The air blower 140 draws in hot air inside the heating cooking compartment 50 through the suction hole portion, and blows hot air into the heating cooking compartment 50 through the blow-out hole portion. To be more specific, the air blower 140 draws in hot air from a central portion inside the heating cooking compartment 50 and blows the hot air to a peripheral border portion inside the heating cooking compartment 50. As a result, the entire inside of the heating cooking compartment 50 can be heated by driving the air blower 140.

As illustrated in FIGS. 2, 3, and 5 to 7 again, the heating cooking compartment 50 further includes an intake hole portion 81, an exhaust hole portion 82, an intake damper unit 83, and an exhaust damper unit 84.

The intake hole portion 81 allows the inside and the outside of the heating cooking compartment 50 to communicate with each other. Specifically, the intake hole portion 81 is disposed on the left wall 52. The intake hole portion 81 has, for example, a quadrangular shape. Specifically, the intake hole portion 81 includes, for example, a plurality of punched holes. A punched hole has, for example, a circular shape. A diameter of a punched hole of the intake hole portion 81 is, for example, 3 mm or larger and 4 mm or smaller in order to prevent microwaves from leaking. The diameter is preferably 3.4 mm.

The intake damper unit 83 opens and closes the intake hole portion 81. The intake damper unit 83 is attached to an outer side of the left wall 52. For example, in a case where the intake damper unit 83 opens the intake hole portion 81, the inside and the outside of the heating cooking compartment 50 communicate with each other. As a result, air is guided to the intake hole portion 81. On the other hand, in a case where the intake damper unit 83 closes the intake hole portion 81, the inside and the outside of the heating cooking compartment 50 do not communicate with each other. As a result, air is not guided to the intake hole portion 81.

In addition, the exhaust hole portion 82 allows the inside and the outside of the heating cooking compartment 50 to communicate with each other. Specifically, the exhaust hole portion 82 is disposed on the right wall 51. The exhaust hole portion 82 has, for example, a quadrangular shape. Specifically, the exhaust hole portion 82 includes, for example, a plurality of punched holes. A punched hole has, for example, a circular shape. A diameter of a punched hole of the exhaust hole portion 82 is, for example, 3 mm or larger and 4 mm or smaller in order to prevent microwaves from leaking. The diameter is preferably 3.4 mm.

The exhaust damper unit 84 opens and closes the exhaust hole portion 82. The exhaust damper unit 84 is attached to an outer side of the right wall 51. For example, in a case where the exhaust damper unit 84 opens the exhaust hole portion 82, the inside and the outside of the heating cooking compartment 50 communicate with each other. On the other hand, in a case where the exhaust damper unit 84 closes the exhaust hole portion 82, the inside and the outside of the heating cooking compartment 50 do not communicate with each other.

A flow of air inside the heating cooking compartment 50 will be described. First, the intake damper unit 83 opens the intake hole portion 81, and the exhaust damper unit 84 opens the exhaust hole portion 82. As a result, air is guided to the intake hole portion 81. The air is blown into the heating cooking compartment 50 through the intake hole portion 81. The air blown from the intake hole portion 81 moves into the heating cooking compartment 50 in a direction opposite to the third direction D3. Thereafter, the air is discharged from the exhaust hole portion 82 to the outside of the heating cooking compartment 50. The air performs scavenging of steam or the like in the heating cooking compartment 50.

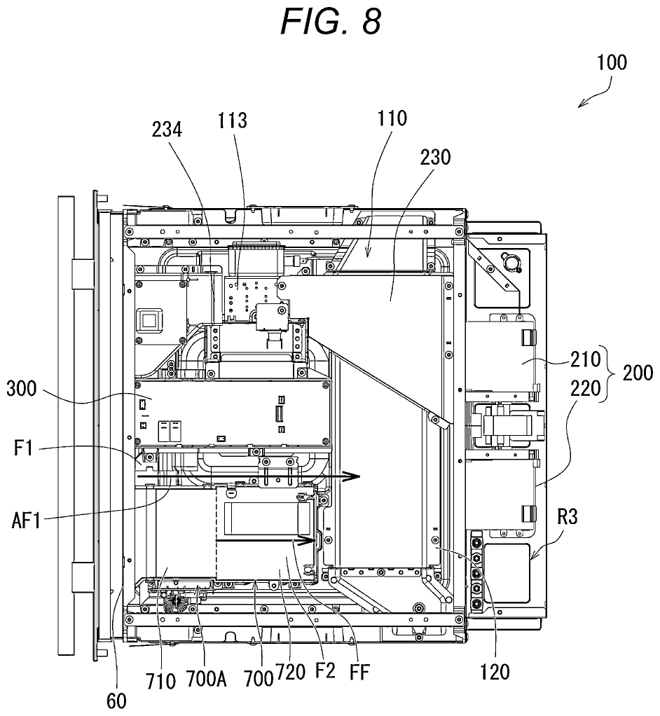

Next, the heating cooker 100 will be further described with reference to FIGS. 2, 5, 7, and 8. FIG. 8 is a plan view illustrating the heating cooker 100 in a state where the housing 10 except for the front wall 60 thereof is removed according to the embodiment.

As illustrated in FIGS. 2 and 7, the heating cooker 100 includes a first fan 200, a first wind direction plate 500, a first guide unit 550, and a second wind direction plate 600.

The first fan 200 generates an air flow. As illustrated in FIGS. 2, 5, and 7, the first fan 200 generates a first air flow AF, a second air flow BF, a third air flow CF, a fourth air flow DF, and a fifth air flow EF. The second air flow BF, the third air flow CF, the fourth air flow DF, and the fifth air flow EF are branches from the first air flow AF. The first fan 200 corresponds to, for example, a “second blast fan”.

The first air flow AF mainly cools the drive motor 72, the second heater unit 130, and the drive unit 144. The second air flow BF mainly cools the first heater unit 120. The third air flow CF mainly performs scavenging of the inside of the heating cooking compartment 50. The fourth air flow DF mainly cools a motor of the intake damper unit 83. The fifth air flow EF mainly cools a motor of the exhaust damper unit 84. The first air flow AF (the first air flow AF1) corresponds to, for example, a “second blast fan air flow”.

For example, the first fan 200 is a Sirocco fan. As illustrated in FIGS. 7 and 8, the first fan 200 is disposed between the rear wall 55 of the heating cooking compartment 50 and the rear outer wall 15 of the housing 10. Specifically, the first fan 200 is disposed in the region in which the first space R1 and the third space R3 overlap each other. The first fan 200 is disposed between the heating cooking compartment 50 and the housing 10, and suctions air from the suction ports 62 to a space between the heating cooking compartment 50 and the housing 10. The first fan 200 includes a left fan portion 210 and a right fan portion 220.

The left fan portion 210 supplies cooling air to a left region of the first fan 200 to generate the left-side first air flow AF1 that is a part of the first air flow AF. The left fan portion 210 is positioned at the same height as the plurality of suction ports 62. The left fan portion 210 generates a negative pressure having a pressure lower than an external normal pressure on an upstream side of the left fan portion 210 in order to draw air. The left fan portion 210 takes air outside the heating cooker 100 into the first space R1 and generates the left-side first air flow AF1 between the upper wall 53 of the heating cooking compartment 50 and the upper outer wall 13 of the housing 10. In addition, the left fan portion 210 generates a left-side first air flow AF2 between the rear wall 55 of the heating cooking compartment 50 and the rear outer wall 15 of the housing 10. The left fan portion 210 discharges the air in the first space R1 into the third space R3. As illustrated in FIG. 7, the left-side first air flow AF1 is generated by the negative pressure on an upstream side of the left fan portion 210. The left-side first air flow AF2 is generated by a positive pressure on a downstream side of the left fan portion 210.

As illustrated in FIG. 5, the right fan portion 220 is positioned at the same height as the plurality of suction ports 62. The right fan portion 220 generates, on an upstream side of the left fan portion 220, a negative pressure having a pressure lower than an external normal pressure in order to draw air. The right fan portion 220 takes air outside the heating cooker 100 into the first space R1 and generates the right-side first air flow AF1 between the upper wall 53 of the heating cooking compartment 50 and the upper outer wall 13 of the housing 10. In addition, the right fan portion 220 generates the right-side first air flow AF2 between the rear wall 55 of the heating cooking compartment 50 and the rear outer wall 15 of the housing 10. The right fan portion 220 discharges the air in the first space R1 into the third space R3. As illustrated in FIG. 7, the right-side first air flow AF1 is generated with the negative pressure on an upstream side of the right fan portion 220. The right-side first air flow AF2 is generated with a positive pressure on a downstream side of the right fan portion 220. The left-side first air flow AF2 and the right-side first air flow AF2 are joined downstream of the first fan 200 (third space R3). That is, the first fan 200 draws in air from the suction ports 62 to a space between the housing 10 and the heating cooking compartment 50 to form the first air flow AF1. The first fan 200 blows the first air flow AF2 toward the drive unit 144 that is a first cooling target portion. The first air flow AF1 is generated with the negative pressure, and the first air flow AF2 is generated with a positive pressure.

As illustrated in FIGS. 5 and 8, the first air flow AF1 flows through a first flow channel F1. Specifically, the first flow channel F1 is formed between the suction ports 62 and the first fan 200.

As illustrated in FIG. 7, the first wind direction plate 500 includes a first skew plate 501, a second skew plate 503, and a horizontal plate 502.

The first skew plate 501 guides the third air flow CF to the suction port 501a of the intake damper unit 83. The third air flow CF is a part of the left-side first air flow AF2 flowing along the first skew plate 501. The first skew plate 501 guides the fourth air flow DF to the suction port 501b directed to the left wall 52. The fourth air flow DF is the remaining part of the left-side first air flow AF2 flowing along the first skew plate 501. Specifically, the first skew plate 501 is disposed on the heat shield plate 146. The first skew plate 501 is provided upright on the heat shield plate 146. The first skew plate 501 extends from below the left fan portion 210 toward the left wall 52.

The second skew plate 503 guides the second air flow BF to the suction port 503a of the first heater unit 120. The second air flow BF is a part of the left-side first air flow AF2 flowing along the second skew plate 503. The second skew plate 503 guides the fourth air flow DF to the suction port 501b directed to the left wall 52. The fourth air flow DF is the remaining part of the left-side first air flow AF2 flowing along the second skew plate 503. That is, the fourth air flow DF includes the remaining part of the left-side first air flow AF2 flowing along the first skew plate 501 and the remaining part of the left-side first air flow AF2 flowing along the second skew plate 503. The second skew plate 503 is disposed on the heat shield plate 146. The second skew plate 503 is provided upright on the heat shield plate 146. The second skew plate 503 is positioned on the upper side from the first skew plate 501. The second skew plate 503 extends from below the left fan portion 210 toward the left wall 52.

The horizontal plate 502 is disposed on the left wall 52. The horizontal plate 502 is provided upright on the left wall 52. The horizontal plate 502 passes below the intake damper unit 83 from the rear wall 55 and extends toward the front wall 60.

The first guide unit 550 guides the second air flow BF from the left fan portion 210 to the first heater unit 120. Specifically, the first guide unit 550 is a cylindrical body. The cylindrical body has the suction port 503a and a blow-out port. The cylindrical body is disposed on the left wall 52. The suction port 503a is open in the direction opposite to the second direction D2. The blow-out port is open toward the first heater unit 120 and the intake hole portion 81.

As illustrated in FIGS. 2 and 7, the second wind direction plate 600 includes a skew plate 601 and a horizontal plate 602.

The skew plate 601 guides the fifth air flow EF to the exhaust damper unit 84. The fifth air flow EF is a part of the right-side first air flow AF2. The skew plate 601 is disposed on the heat shield plate 146. The skew plate 601 is provided upright on the heat shield plate 146. The skew plate 601 extends from below the right fan portion 220 toward the right wall 51.

The horizontal plate 602 is disposed on the right wall 51. The horizontal plate 602 is provided upright on the right wall 51. The horizontal plate 602 passes below the exhaust damper unit 84 from the rear wall 55 and extends toward the front wall 60.

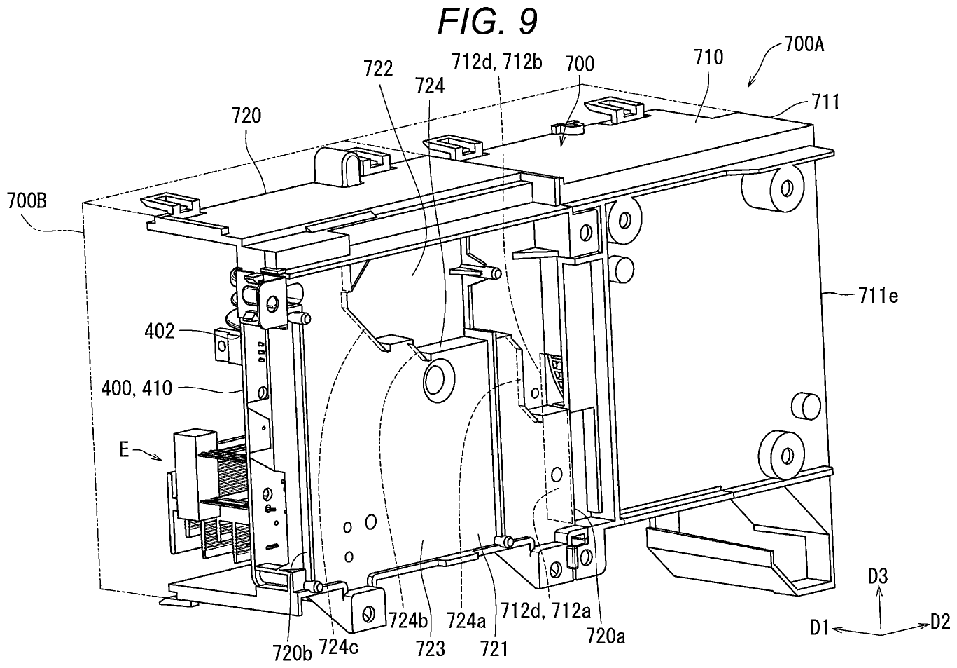

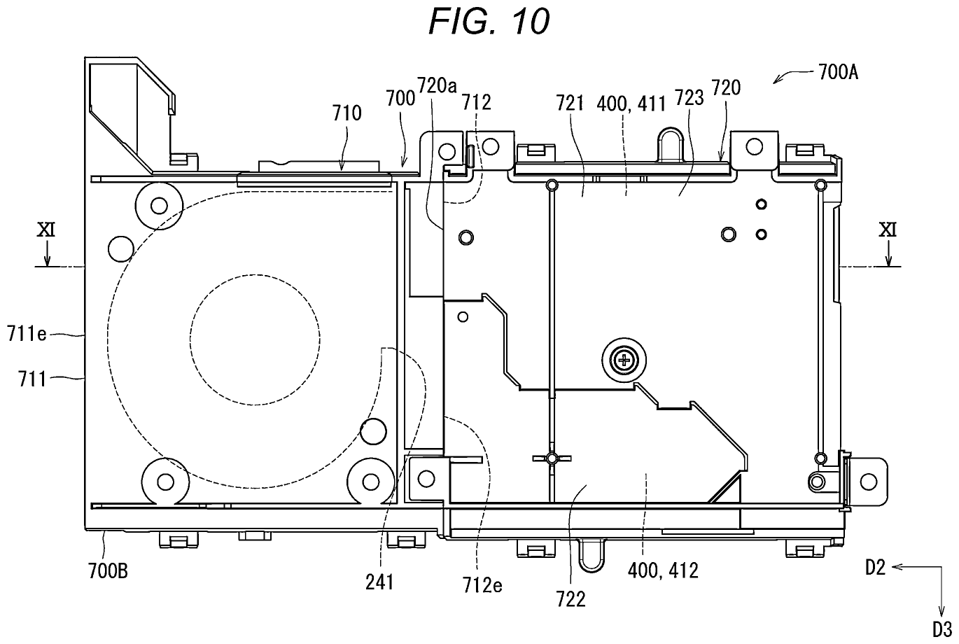

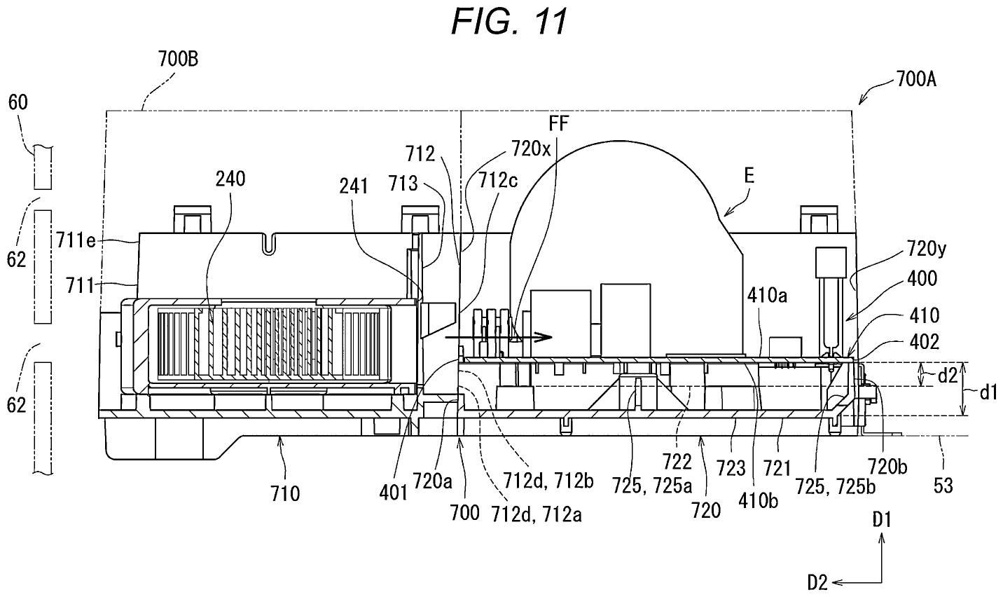

Next, the heating cooker 100 will be further described with reference to FIGS. 2, 5 and 7 to 11. FIG. 9 is a perspective view illustrating an inverter unit 700A according to the embodiment. To be specific, FIG. 9 illustrates the external appearance of the inverter unit 700A when viewed from a lower rear side in which an upper half portion of the division partition 700 is omitted. FIG. 10 is a plan view illustrating the inverter unit 700A according to the embodiment. To be specific, FIG. 10 illustrates the external appearance of the inverter unit 700A when viewed from below in which the upper half portion of the division partition 700 is omitted. FIG. 11 is a cross-sectional view along line XI-XI in FIG. 10.

As illustrated in FIGS. 5, 7, and 8, the heating cooker 100 further includes the inverter unit 700A. The inverter unit 700A is an inverter device having a self-cooling function. As illustrated in FIG. 5, the inverter unit 700A includes a second fan 240, an inverter power supply 400, and a division partition 700.

The second fan 240 generates an air flow. As illustrated in FIGS. 5 and 8, the second fan 240 is disposed in the first flow channel F1. For example, the second fan 240 is a Sirocco fan. As illustrated in FIG. 11, the second fan 240 has a fan blow-out port 241 that blows out air. The second fan 240 corresponds to, for example, a “first blast fan”.

As illustrated in FIGS. 5 and 8, the second fan 240 forms a sixth air flow FF by air blown out from the fan blow-out port 241. The sixth air flow FF corresponds to, for example, a “first blast fan air flow”.

As illustrated in FIGS. 10 and 11, the fan blow-out port 241 blows out air toward the inverter power supply 400. Specifically, the second fan 240 suctions air from the first direction D1 side via the suction ports 62, and blows the air from the fan blow-out port 241 toward a direction opposite to the second direction D2.

The inverter power supply 400 changes a frequency and a magnitude of voltage. As illustrated in FIGS. 5 and 9 to 11, the inverter power supply 400 is disposed behind the second fan 240. As illustrated in FIGS. 5 and 8, the inverter power supply 400 is disposed in the first flow channel F1.

As illustrated in FIGS. 9 to 11, the inverter power supply 400 includes electric components E and a board 410. The inverter power supply 400 has a first end portion 401 on a side close to the suction ports 62 and a second end portion 402 on a side far from the suction ports 62. The board 410 corresponds to, for example, a “circuit board”.

Examples of the electric components E include a rectifier circuit that rectifies power obtained from a commercial power source, a control circuit, a semiconductor switching element that transmits output power of the rectifier circuit to a resonance circuit via a filter circuit in response to an output signal of the control circuit, a step-up transformer that steps up and outputs resonance power of the resonance circuit, and a high-voltage rectifier circuit (all not illustrated).

The board 410 supports the electric components E. As illustrated in FIG. 11, the board 410 is disposed to be orthogonal to the first direction D1. The board 410 is disposed between the housing 10 and the heating cooking compartment 50. In the board 410, a plurality of electric components E are mounted on a surface 410a on the first direction D1 side. A surface 410b of the board 410 on the opposite side of the first direction D1 is mainly a solder surface.

The division partition 700 divides a flow channel through which an air flow flows. The division partition 700 is made of, for example, a synthetic resin. As illustrated in FIGS. 5 and 8, by the division partition 700, a second flow channel F2 in which the sixth air flow FF flows from the fan blow-out port 241 of the second fan 240 toward the board 410 (the inverter power supply 400) is divided from the first flow channel F1. As a result, cooling performance for the cooling target portion disposed upstream of the cooling fan can be enhanced. Specifically, since the division partition 700 is provided to divide the first flow channel F1 to form the second flow channel F2 in which the sixth air flow FF blown out from the fan blow-out port 241 of the second fan 240 toward the board 410 flows, it is possible to reduce suction of air from between the fan blow-out port 241 of the second fan 240 and the board 410, and it is possible to secure a volume of cooling air flowing toward the inverter power supply 400, even in a case where the board 410 is disposed in a negative pressure environment of the first fan 200. That is, the sixth air flow FF can be reliably directed to the inverter power supply 400.

The inverter unit 700A will be further described with reference to FIGS. 9 to 11. As illustrated in FIGS. 9 to 11, the division partition 700 includes a first case 710 and a second case 720.

The first case 710 accommodates the second fan 240. The first case 710 and the second fan 240 constitute a board blower 700B. Accordingly, the board blower 700B has the fan blow-out port 241 that blows out air toward the board 410, and forms the sixth air flow FF by the air blown out from the fan blow-out port 241. The board blower 700B corresponds to, for example, a “air blower”.

The first case 710 has a tubular structure having a rectangular cross section. The first case 710 is fixed to the upper wall 53. The first case 710 has a first suction port 711 and a first blow-out port 712.

The first suction port 711 is formed at an end of the first case 710 on a side close to the suction ports 62 and suctions air.

An edge portion 711e forming the first suction port 711 faces the suction ports 62. The edge portion 711e is preferably brought into contact with the front wall 60. Specifically, the edge portion 711e preferably surrounds some openings (suction ports 62) of a plurality of suction ports 62 and is brought into contact with the front wall 60. Consequently, it is possible to reduce cooling air (air) suctioned from a gap between the first suction port 711 of the first case 710 and the front wall 60 of the housing 10 with a negative pressure of the first fan 200. As a result, the volume of cooling air flowing toward the inverter power supply 400 can be further secured.

As illustrated in FIGS. 10 and 11, the first blow-out port 712 is formed at an end portion of the first case 710 on a side far from the suction port 62 and blows out air. The first blow-out port 712 corresponds to, for example, a “first blow-out port” of the board blower 700B. The first blow-out port 712 is open toward the first end portion 401 of the inverter power supply 400 on the side close to the suction port 62. Consequently, it is possible to reduce air suctioned with the negative pressure in a region from the second fan 240 to the inverter power supply 400, and the volume of cooling air toward the inverter power supply 400 can be further secured.

In the embodiment, an edge portion 712e forming the first blow-out port 712 is in contact with the first end portion 401 of the inverter power supply 400. As compared with the case where the edge portion 712e forming the first blow-out port 712 of the first case 710 and the first end portion 401 of the inverter power supply 400 are separated from each other, it is possible to reduce the air suctioned with the negative pressure of the first fan 200 from a gap between the edge portion 712e forming the first blow-out port 712 of the first case 710 and the first end portion 401 of the inverter power supply 400. As a result, the volume of cooling air flowing toward the inverter power supply 400 can be further secured.

The first blow-out port 712 includes a first communication port 712a, a second communication port 712b, a third communication port 712c, and a fourth communication port 712d.

As illustrated in FIG. 11, the third communication port 712c is an opening of a portion of the first blow-out port 712 on the first direction D1 side from the board 410. The fourth communication port 712d is an opening of a portion of the first blow-out port 712 on an opposite side to the first direction D1 from the board 410. That is, the fourth communication port 712d is positioned closer to the heating cooking compartment 50 than the third communication port 712c is.

As illustrated in FIGS. 9 and 11, the fourth communication port 712d includes the first communication port 712a and the second communication port 712b. The first communication port 712a is an opening of a portion on an opposite side to the third direction D3. The second communication port 712b is an opening of a portion on the third direction D3 side.

The second case 720 accommodates the inverter power supply 400. The second case 720 has a tubular structure having a rectangular cross section. In other words, the division partition 700 includes the second case 720 that accommodates the board 410.

The second case 720 is fixed to the upper wall 53. As illustrated in FIG. 10, the board 410 of the inverter power supply 400 has a first region 411 and a second region 412.

Of the electric components E, the first region 411 supports an electric component E that generates a low voltage. The first region 411 is mainly positioned on a side of the board 410 opposite to the third direction D3. An area of the first region 411 decreases in the second direction D2.

The second region 412 has a higher voltage than that of the first region 411. The second region 412 supports an electric component E that generates a voltage higher than that of the electric component E supported by the first region 411, of the electric components E. The second region 412 is mainly positioned on the third direction D3 side of the board 410. An area of the second region 412 increases in the second direction D2. Note that the second region 412 is not present at an end portion of the board 410 on a side opposite to the second direction D2.

As illustrated in FIGS. 9 and 11, the second case 720 has a first case end portion 720a and a second case end portion 720b.

The first case end portion 720a is an end portion of the second case 720 close to the suction port 62. A suction port 720x of the second case 720 is defined by the first case end portion 720a. As illustrated in FIG. 10, the first case end portion 720a is brought into contact with the edge portion 712e of the first blow-out port 712. Consequently, the first case 710 and the second case 720 communicate with each other.

As illustrated in FIG. 11, the second case end portion 720b is an end portion of the second case 720 far from the suction port 62. A blow-out port 720y of the second case 720 is defined by the second case end portion 720b.

The sixth air flow FF flows in the second case 720 from the first case end portion 720a. That is, as illustrated in FIGS. 5 and 8, at least a part of the sixth air flow FF flows in the second flow channel F2 in the second case 720.

As illustrated in FIGS. 9 to 11, the second case 720 has a bottom wall portion 723. The bottom wall portion 723 functions as a partition between the first flow channel F1 and the inverter power supply 400. The inverter power supply 400 is disposed away from the bottom wall portion 723. The bottom wall portion 723 includes a first bottom wall portion 721, a second bottom wall portion 722, and a vertical wall portion 724.

The first bottom wall portion 721 faces the first region 411 of the board 410. As illustrated in FIG. 11, the first bottom wall portion 721 is disposed apart from the upper wall 53 in the first direction D1. A separation distance between the first region 411 and the first bottom wall portion 721 is a separation distance d1.

The second bottom wall portion 722 faces the second region 412 of the board 410. The second bottom wall portion 722 is disposed apart from the upper wall 53 in the first direction D1. A separation distance between the second region 412 and the second bottom wall portion 722 is a separation distance d2. The separation distance d2 is shorter than the separation distance d1. That is, the separation distance d2 between the second region 412 and the second bottom wall portion 722 is shorter than the separation distance d1 between the first region 411 and the first bottom wall portion 721. Since the separation distance d2 is shorter than the separation distance d1 between the first region 411 and the first bottom wall portion 721, it is possible to reduce adhesion of dust mixed in the cooling air to the second region 412.

The first communication port 712a of the first blow-out port 712 communicates with a space between the first region 411 and the first bottom wall portion 721.

The second communication port 712b of the first blow-out port 712 communicates with both a space between the second region 412 and the second bottom wall portion 722 and a space between the second bottom wall portion 722 and the upper wall 53. In other words, the second communication port 712b communicates with a space between the second region 412 and the heating cooking compartment 50. Consequently, cooling air can be supplied to both the space between the first region 411 and the first bottom wall portion 721 and the space between second region 412 and the heating cooking compartment 50.

The first blow-out port 712 communicates with both the space between the first region 411 and the first bottom wall portion 721 and the space between the second region 412 and the heating cooking compartment 50. One single opening enables the cooling air to be supplied between the first region 411 and the first bottom wall portion 721 and between the second bottom wall portion 722 and the heating cooking compartment 50.

As illustrated in FIGS. 10 and 11, the fan blow-out port 241 of the second fan 240 is disposed at a position spanning between the surface 410a on one side of the board 410 and the surface 410b on the other side of the board 410. Consequently, the surface 410a on one side and the surface 410b on the other side of the board 410 of the inverter power supply 400 can be simultaneously cooled.

The first blow-out port 712 of the first case 710 is disposed at a position spanning between the surface 410a on one side of the board 410 and the surface 410b on the other side of the board 410. Regardless of the position of the fan blow-out port 241 of the second fan 240, the single opening enables the surface 410a on one side and the surface 410b on the other side of the board 410 of the inverter power supply 400 to be simultaneously cooled.

As illustrated in FIG. 11, the board 410 is positioned between the third communication port 712c and the fourth communication port 712d. Consequently, regardless of the position of the fan blow-out port 241 of the second fan 240, both the surface 410a on one side and the surface 410b on the other side of the board 410 of the inverter power supply 400 can be simultaneously cooled.

As illustrated in FIG. 11, the second case 720 has a flow restricting portion 725. The flow restricting portion 725 is disposed on an upper surface of the first bottom wall portion 721.

The flow restricting portion 725 restricts a flow quantity of the air flowing in the second case 720. The flow restricting portion 725 extends from the bottom wall portion 723 of the second case 720 toward the inverter power supply 400 and is separated from the inverter power supply 400. The sixth air flow FF flowing in the division partition 700 can be guided toward the inverter power supply 400. That is, the volume of cooling air toward the inverter power supply 400 can be increased. As illustrated in FIG. 11, the flow restricting portion 725 includes a first flow restricting portion 725a and a second flow restricting portion 725b.

The first flow restricting portion 725a extends in the first direction D1 from the first bottom wall portion 721 to restrict a flow channel area between the first bottom wall portion 721 and the board 410. The first flow restricting portion 725a is disposed in the third direction D3 on a part of the first bottom wall portion 721. The part of the first bottom wall portion 721 is a position corresponding to the low-voltage electric component E of the electric components E mounted in the first region 411. The first flow restricting portion 725a is provided between the first case end portion 720a and the second case end portion 720b. In the second direction D2, cooling performance of the inverter power supply 400 corresponding to a middle position of the second case 720 can be increased. The first flow restricting portion 725a is not limited to being disposed in the third direction D3 on the part of the first bottom wall portion 721. The first flow restricting portion 725a may be provided from one end portion to the other end portion in the third direction D3.

The second flow restricting portion 725b is provided at the second case end portion 720b of the second case 720, and is inclined in a direction away from the heating cooking compartment 50 toward the opposite side to the second direction D2. The cooling performance of the inverter power supply 400 corresponding to the second case end portion 720b of the second case 720 can be increased. In addition, a ratio of the sixth air flow FF flowing to the surface 410a on one side and the surface 410b on the other side of the board 410 can be adjusted by the flow restricting portion 725.

As illustrated in FIG. 9, the vertical wall portion 724 connects the first bottom wall portion 721 and the second bottom wall portion 722. The vertical wall portion 724 has a first vertical wall opening 724a, a second vertical wall opening 724b, and a third vertical wall opening 724c.

The first vertical wall opening 724a, the second vertical wall opening 724b, and the third vertical wall opening 724c intersect the second direction D2. The first vertical wall opening 724a faces a part of the fourth communication port 712d. The first vertical wall opening 724a is positioned on the third direction D3 side from the first communication port 712a. The second vertical wall opening 724b is positioned on the third direction D3 side from the first vertical wall opening 724a. The third vertical wall opening 724c is positioned on the third direction D3 side from the second vertical wall opening 724b. A part of the sixth air flow FF blown out from the second communication port 712b flows into the space between the first region 411 and the first bottom wall portion 721 through the first vertical wall opening 724a, the second vertical wall opening 724b, and the third vertical wall opening 724c.

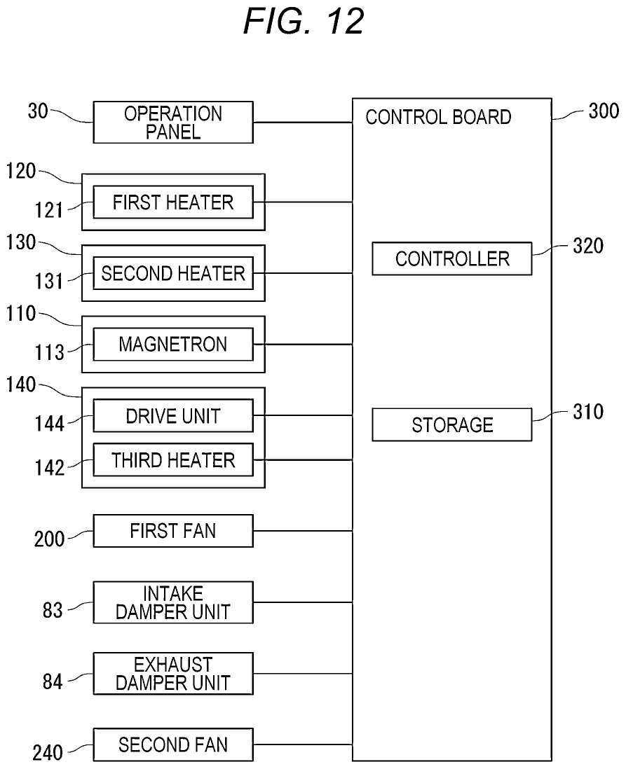

Next, the heating cooker 100 will be further described with reference to FIGS. 7 and 12. FIG. 12 is a block diagram illustrating a configuration of the heating cooker 100 according to the embodiment.

As illustrated in FIGS. 7 and 12, the heating cooker 100 further includes a control board 300.

The control board 300 includes a storage 310 and a controller 320. The storage 310 includes a random access memory (RAM) and a read only memory (ROM). The storage 310 stores control programs for controlling an operation of each component of the heating cooker 100.

The controller 320 is a hardware circuit including a processor such as a central processing unit (CPU). The controller 320 executes the control programs stored in the storage 310.

As illustrated in FIG. 7, the heating cooker 100 further includes a front duct member 234 and a rear duct member 230.

A configuration of the heating cooker 100 will be described in detail. In the embodiment, the heating cooker 100 has, as heating cooking modes, a “microwave heating mode”, a “hot air circulation heating mode”, and a “grill heating mode”. The “microwave heating mode” is a mode for heating and cooking a heating-target object mainly by radiating microwaves into the heating cooking compartment 50. The “grill heating mode” means a mode for heating and cooking a heating-target object mainly by causing heat generated from the first heater unit 120 and the second heater unit 130 to radiate to the heating-target object. The “hot air circulation heating mode” is a mode for heating and cooking a heating-target object mainly by circulating hot air throughout the heating cooking compartment 50 to ensure a uniform temperature in the heating cooking compartment 50.

The controller 320 executes control programs stored in the storage 310, thereby controlling driving of the microwave supply unit 110, driving of the air blower 140, driving of the first heater unit 120, driving of the second heater unit 130, driving of the first fan 200, and driving of the second fan 240.

To be specific, the controller 320 controls the operation panel 30, the magnetron 113, the first heater 121, the second heater 131, the third heater 142, the drive unit 144, the first fan 200, the intake damper unit 83, and the exhaust damper unit 84. For example, in the case where the “microwave heating mode” is selected, the controller 320 drives the magnetron 113, the first fan 200, the intake damper unit 83, and the exhaust damper unit 84. In addition, in the case where the “grill heating mode” is selected, the controller 320 drives the first heater 121, the second heater 131, the first fan 200. Further, in the case where the “hot air circulation heating mode” is selected, the controller 320 drives the drive unit 144, the first fan 200, and drives at least one of the first heater 121, the second heater 131, and the third heater 142. The second fan 240 is driven in synchronization with an operation of the inverter power supply 400 regardless of the selected mode.

The embodiment of the present disclosure has been described above with reference to the drawings. However, the present disclosure is not limited to the above embodiment, and can be implemented in various aspects without departing from the gist thereof. For easy understanding, the drawings schematically illustrate the individual components mainly, and the thicknesses, lengths, number, and the like of the individual components illustrated in the drawings are different from actual ones for convenience of preparation of the drawings. In addition, the materials, shapes, dimensions, and the like of the individual components illustrated in the above embodiment are merely examples, and are not particularly limited, and various modifications can be made without substantially departing from the effects of the present disclosure.
(1) As described with reference to FIGS. 1 to 12, in the embodiment, an example in which the first cooling target portion is the drive unit 144 has been described, but the present disclosure is not limited thereto. Any electric component that needs to be cooled may be selected, and for example, the drive motor 72 of the table 71 may be selected.
(2) As described with reference to FIGS. 1 to 12, in the embodiment, an example in which the division partition 700 includes two members of the first case 710 and the second case 720 has been described, but the present disclosure is not limited thereto. The division partition 700 may include a single case or three or more cases. In addition, only the case that accommodates the second fan 240 may be included, or only the case that accommodates a second cooling target portion may be included.
(3) As described with reference to FIGS. 1 to 12, in the embodiment, an example in which the second cooling target portion includes the inverter power supply 400 has been described, but the present disclosure is not limited thereto. The second cooling target portion may be an electric component other than the inverter power supply 400.
(4) As described with reference to FIGS. 1 to 12, in the embodiment, the state where the heating cooker 100 has, as heating cooking modes, a “microwave heating mode”, a “hot air circulation heating mode”, and a “grill heating mode” is provided, but the present disclosure is not limited thereto. The heating cooker 100 may have at least any one of the heating modes. The present disclosure provides a heating cooker, and has industrial applicability.

What is claimed is:

1. A heating cooker comprising:
a heating cooking compartment configured to accommodate a heating-target object;
a housing configured to accommodate the heating cooking compartment;
a circuit board disposed between the housing and the heating cooking compartment;
an air blower having a first blow-out port accommodating a first blast fan and blowing out air toward the circuit board, the air blower being configured to form a first blast fan air flow with air blown out from the first blow-out port; and
a division partition configured to divide a flow channel through which the first blast fan air flow flows from the first blow-out port toward the circuit board, wherein
the division partition includes a board case configured to accommodate the circuit board,
the board case includes a bottom wall portion functioning as a partition between the heating cooking compartment and the circuit board,
the circuit board is disposed apart from the bottom wall portion,
the first blow-out port is disposed at a position spanning between a surface on one side and a surface on another side of the circuit board, and
the board case includes, on the bottom wall portion, a flow restricting portion restricting a flow quantity of air flowing in the board case.

2. The heating cooker according to claim 1, wherein the flow restricting portion extends from the bottom wall portion of the board case toward the circuit board and is separated from the circuit board.

3. The heating cooker according to claim 1, wherein the flow restricting portion is provided between an end portion of the board case on a side closer to a suction port and an end portion of the board case on a side farther from the suction port.

4. The heating cooker according to claim 1, wherein the flow restricting portion is provided in a second blow-out port of the board case, and is inclined in a direction away from the heating cooking compartment toward an end portion of the second blow-out port.

5. The heating cooker according to claim 1, wherein
the circuit board includes
a first region, and
a second region having a voltage higher than a voltage of the first region,
the bottom wall portion includes
a first bottom wall portion facing the first region, and
a second bottom wall portion facing the second region, and
the flow restricting portion is provided on the first bottom wall portion.

6. The heating cooker according to claim 1, further comprising a second blast fan configured to suction air from an outside to a space between the housing and the heating cooking compartment to form a second blast fan air flow,
wherein the circuit board is disposed upstream from the second blast fan.
